(19) United States
(12) Patent Application Publication
(10) Pub. No.: US 2026/0339412 A1
(43) Pub. Date: Oct. 29, 2026

(54) SYNTHETIC VOLTAGE SIGNALS

(71) Applicant: GOOGLE LLC, Mountain View, CA (US)

(72) Inventor: Juha Joonas Oikarinen, Los Gatos, CA (US)

(21) Appl. No.: 19/109,977

(22) PCT Filed: Sep. 7, 2022
(86) PCT No.: PCT/US2022/042764

§ 371 Date: Mar. 7, 2025

(51) Int. Cl. G06F 1/30

(52) U.S. Cl. CPC G06F 1/305

(57) ABSTRACT

Methods, systems, and apparatus, including computer programs encoded on computer storage media, for injecting synthetic voltage signals. One of the methods includes initiating, by a processing core, a transition from executing in a low-power state to executing in a high-power state. The device injects a synthetic voltage signal into a voltage feedback line of the power manager to cause the power manager to react sooner to the transition by increasing the current supplied to the processing core. The power manager uses the synthetic voltage signal to increase current supplied to the processing core after the processing core transitions from the low-power state to the high-power state.

### BACKGROUND

This specification relates to power management of computing devices.

Computing devices, particularly battery-powered computing devices such as mobile phones, laptops, and tablets, employ many strategies to provide high computing performance with a long battery life. To do so, such devices reduce power consumption when computing demands are low. For example, some devices seek to conserve power by entering high-power states when there is computing work to be done and then entering a low-power state when the computing work is complete.

The power efficiency of entering and exiting these differential power states is highly dependent on how quickly the device can transition between the states. However, there are real physical limitations on how quickly a device can enter a high power state. One reason for this is that there are typically physical electronic components, e.g., inductors, arranged between a current regulator and a compute core that impose physical limits on how quickly the current can be increased.

Because of this physical limitation on increasing the current, devices can employ mitigation strategies to make sure that ramping up computing workloads before current is fully increased does not cause an unacceptable voltage drop that can make the device crash or malfunction. Devices can employ several strategies to help control such undesirable outcomes.

One example is a voltage droop detector that monitors the core voltage of the device. When the voltage drops below a particular threshold, e.g., due to ramping up computing workloads, the system slows the clock frequency to prevent the voltage dropping too far. However, slowing the clock frequency has the drawback of reducing the compute power of the device because it then operates more slowly.

Another example is architectural mitigation, which uses a mapping between expected voltage drop and instruction types or sequences. If an upcoming instruction sequence has an expected voltage drop that is undesirable, the system can execute the instructions more slowly. This approach, too, has the undesirable feature that compute power is throttled to prevent an unsafe drop in voltage.

### SUMMARY

This specification describes how a system can use synthetic voltage signals to improve the power performance of a computing device having a power manager that uses voltage feedback signals to control increases in current. Injecting synthetic voltage signals into the voltage feedback signal has the effect that the power manager can react to power consumption spikes faster while reducing the adverse effects of frequency mitigation measures on computational performance.

Particular embodiments of the subject matter described in this specification can be implemented so as to realize one or more of the following advantages. Using synthetic voltage signals improves the computing performance and power efficiency of computing devices in a number of ways. First, synthetic voltage signals allow a computing device to more quickly transition from a low-power state to a high-power state, which improves the computing performance of the device. Synthetic voltage signals also reduce the adverse impacts of frequency throttling. Using synthetic voltage signals generated by a processing core also allows these performance and efficiency improvements to be implemented without redesigning or modifying the power manager.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1A is a diagram that illustrates an example system that uses architectural mitigation.

FIG. 1B is a diagram that illustrates an example system that uses clock frequency throttling mitigation.

FIG. 2A illustrates how a synthetic voltage signal makes the voltage recovery faster.

FIG. 2B illustrates how a synthetic voltage signals makes frequency recovery faster.

FIG. 3 illustrates how the power manager reacts with architectural mitigation but no synthetic voltage signal.

FIG. 4 illustrates the faster reaction time of the power manager when using a synthetic voltage signal.

FIG. 5 illustrates how synthetic voltage signals can be used to compensate for both architectural and frequency mitigations in the same system.

Like reference numbers and designations in the various drawings indicate like elements.

### DETAILED DESCRIPTION

This specification describes how a system can use synthetic voltage signals to improve the power performance of a computing device having a power manager that uses voltage feedback signals to control increases in current. Injecting synthetic voltage signals into the voltage feedback signal has the effect that the power manager can react to power consumption spikes faster while reducing the adverse effects of frequency mitigation measures on computational performance.

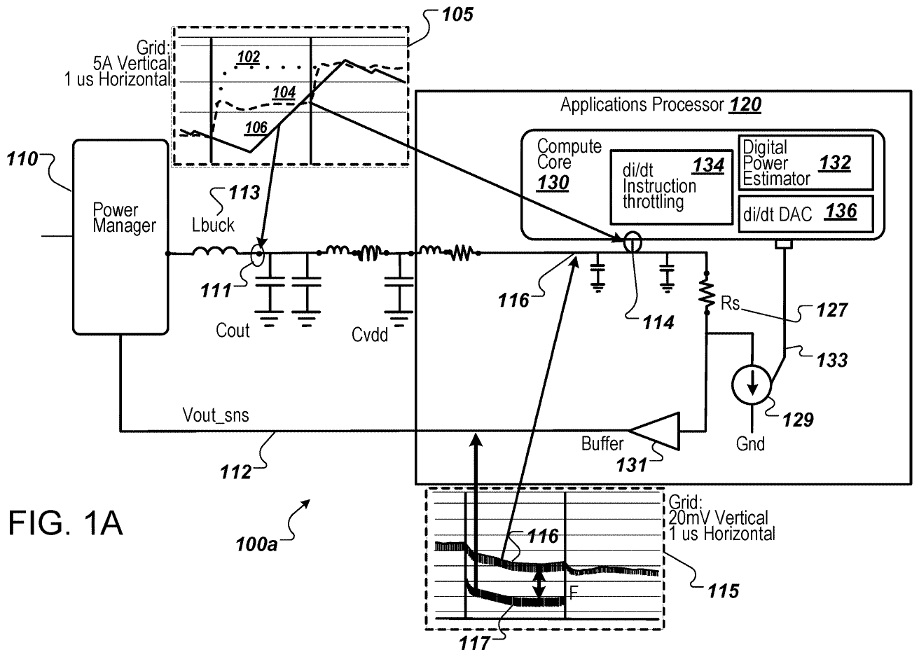

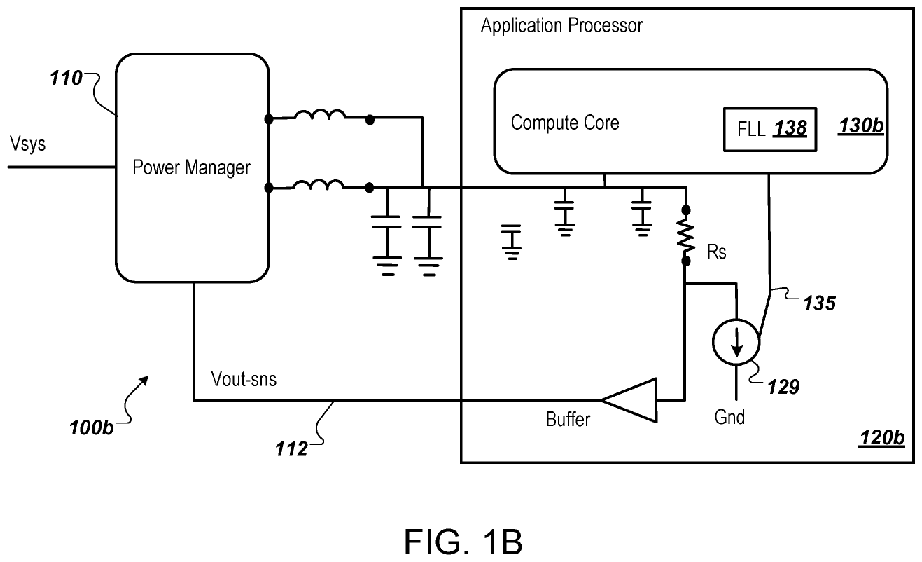

FIG. 1A is a diagram that illustrates an example system 100a that uses architectural mitigation. The system 100a is an example of a system that can use synthetic voltage signals to improve power performance.

The system 100a includes a power manager 110 and an applications processor 120 having a compute core 130. The system 100a can be a part of any appropriate mobile or stationary computing device. For example, the system can be part of a mobile phone, wearable device, tablet, laptop computer, desktop computer, or server. The compute core 130 can be any appropriate computing device that executes instructions.

The power manager 110 can be any appropriate power manager that uses voltage feedback to regulate current supplied to the compute core 130. For example, the power manager 110 can be a buck down converter. The power manager 110 uses a voltage feedback line 112 to receive voltage feedback signals “Vout_sns” in order to adjust the amount of current that is being supplied to the applications processor 120.

In order to generate the voltage feedback signal, the system 100a uses a series resistor 127 in combination with a controlled current source 129 that draws current across the series resistor 127. Changes to the current being consumed by the compute core 130 as the current exists before the series resistor 127 causes corresponding changes to the voltage drop over the resister 127. These voltages are transformed into the voltage feedback signal after being fed through a voltage buffer 131.

The system 100a has at least two computing modes-a low-power mode and a high-power mode. When transitioning from the low-power mode to the high-power mode, the power manager 110 can detect voltage drops from voltage feedback signals received on the voltage feedback line 112.

FIG. 1A includes an inset plot 105 that illustrates the behavior of the components due to architectural mitigation on current supplied by the power manager 110.

The x-axis of the inset plot 105 is time and the y-axis is current at two locations 111 and 114 of the device. The inset plot 105 thus illustrates the relationship between 1) current consumed by the compute core 130 at a location 114 where power is supplied to the compute core and 2) current supplied by the power manager 110, which is referred to as the “buck current” and is measured at a point 111 just beyond a buck inductor 113.

The current consumed from transitioning from a low-power state to a high-power state without any mitigation is illustrated by the dotted line 102. Although as explained above, this might not actually be an option because doing so could cause an unsafe voltage drop.

The current consumed under architectural mitigation when transitioning from the low-power state to the high-power state is illustrated by the dashed line 104. When the compute core 130 performs this mitigation, the current consumed takes two steps up over time, as represented by the dashed line 104.

Lastly, the current supplied by the power manager 110 during the transition with architectural mitigation is illustrated by the solid line 106. Because the power manager 110 has no visibility into what the compute core 130 is doing, the power manager 110 relies on voltage feedback signals to start increasing power. In this example, the power manager 110 senses a voltage drop only after the first step up in current consumption illustrated by the dashed line 104. The power manager 110 then steadily increases the current until a stable state is reached after the computer device performs its second step up in current consumption.

The compute core 130 has functional circuitry for implementing architectural mitigation. The effect of the architectural mitigation is that the compute core 130 will execute instructions more slowly during a transition period from low power to high power until the power manager has had a chance to fully increase the available current. In some implementations, the components effectuating the architectural mitigation do not actually measure the current being supplied by the power manager 110. Rather, they use calculations or lookup tables, or some combination of these, to compute an estimate of how much current each instruction, or sequence of instructions, is expected to consume when executed.

The compute core 130 has a digital power estimator 132 that computes estimates of power consumed for particular instructions or sequences of instructions. A di/dt instruction throttling module 134 can then use a digital power estimate generated by the digital power estimator 132 to control how fast instructions should be executed or throttled.

A di/dt digital-to-analog converter (DAC) 136 can compute a difference between how much power is expected to be consumed and how much power is being supplied to the compute core 130. For example the architectural mitigation might inject three NOP instructions for every one actual payload instruction. Then, there would be a power cost prediction made with the actual payload alone and with the NOP instructions included. The NOP could for example have power cost of say 1 unit, and the payload instructions could have a power cost of 10 units. These costs could be summed over a window of instructions, e.g., 5, 50, or 100 instructions, and the difference between the sums of the costs would represent the delta. A delta signal could then be computed as the unthrottled power cost compared to the throttled power cost, possibly with a precomputed scaling factor.

The system 100a can then use the computed delta 133 to alter the controlled current source 129 in a way that generates a proportional voltage shift across the series resistor 127. For example, the delta can be used to lower the current of the controlled current source 129 to drop the voltage across the series resistor 127 in order to effectively subtract from the voltage feedback signal on the voltage feedback signal line 112. This in effect generates a synthetic voltage signal that is fed into the voltage feedback signal line 112. In some implementations, the compute core 130 can use a programmable GM amplifier to inject the delta signal 133 as a current to affect the operation of the controlled current source 129.

FIG. 1A includes another inset plot 115 that illustrates the shape of the synthetic voltage signal. The x-axis is time and the y-axis is voltage in the inset plot 115. Due to the compute core 130 entering the high-power state, there is a drop in voltage at a location 116 before current arrives at the compute core 130. Thus, in order to cause the power manager 110 to react more quickly, a synthetic voltage signal 117 is fed onto the voltage feedback line 112.

In some implementations, the compute core generates a trajectory-matched synthetic voltage signal 117 that matches the trajectory of the expected drop in voltage 116. In other words, the synthetic voltage signal has a shape that is designed to match the physical properties of the system, and thus substantially matches the expected drop in voltage. As shown in the inset plot 115, while the shape is substantially similar, the synthetic voltage signal has a magnitude that is artificially lower. In effect, the synthetic voltage signal communicates to the power manager 100 that the state of power being supplied is are worse than it actually is, which in turn stimulates the power manager 110 to react earlier and more aggressively than it otherwise would have.

FIG. 1B is a diagram that illustrates an example system 100b that uses clock frequency throttling mitigation. The system 100b has many similarities with the system in 100a, but the system 100b uses an frequency locked loop (FLL) module 138 to throttle the clock frequency of the compute core 130b until the power regular 110 can increase current to the compute core 130b.

In this case, however, the system uses the value of the frequency reduction computed by the FLL 138 to generate the delta signal 135 that affects the controlled current source 129 and thus creates a synthetic voltage signal. The compute core 130b could for example use a programmable GM amplifier to inject the delta signal computed from the value of the frequency reduction, optionally with a scaling factor.

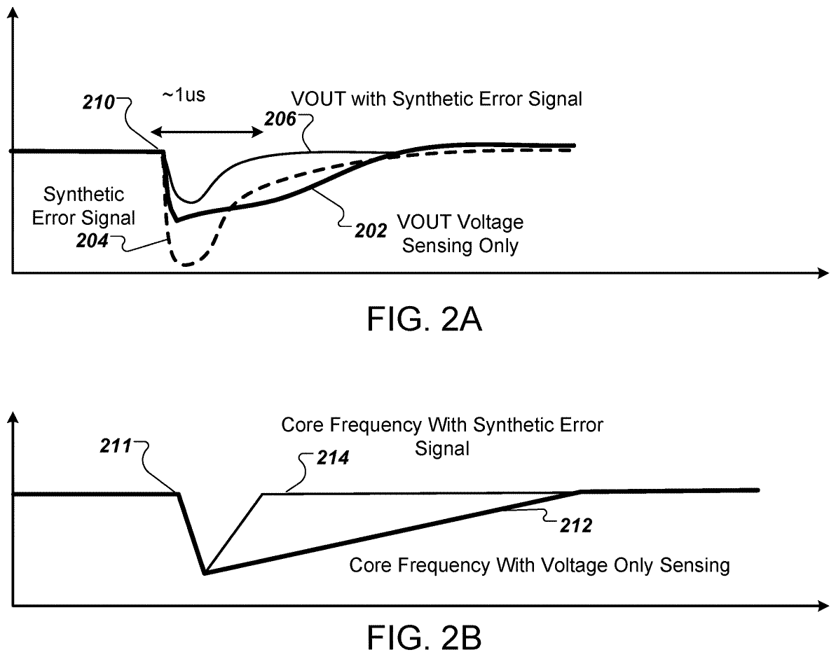

FIG. 2A illustrates how a synthetic voltage signal 204 makes the voltage recovery faster. At a transition point 210, which can, for example, be a transition from a low-power state to a high-power state, the voltage of the compute core drops due to consuming more power.

At the transition point 210, a system can inject a synthetic voltage signal 204, which causes the resulting adjusted voltage 206 to recover more quickly than the ordinary voltage 202 would have without the synthetic voltage signal. As described above, this is because the synthetic error signals causes the power manager to react sooner and, possibly, more aggressively.

FIG. 2B illustrates how a synthetic voltage signals make frequency recovery faster. At the transition point 211, the compute core can implement frequency throttling due to the increased power demands. Thus, the frequency mitigation techniques cause the frequency to drop. Without a synthetic voltage signal, the core frequency 212 recovers more slowly than the core frequency 214 when using synthetic voltage signals.

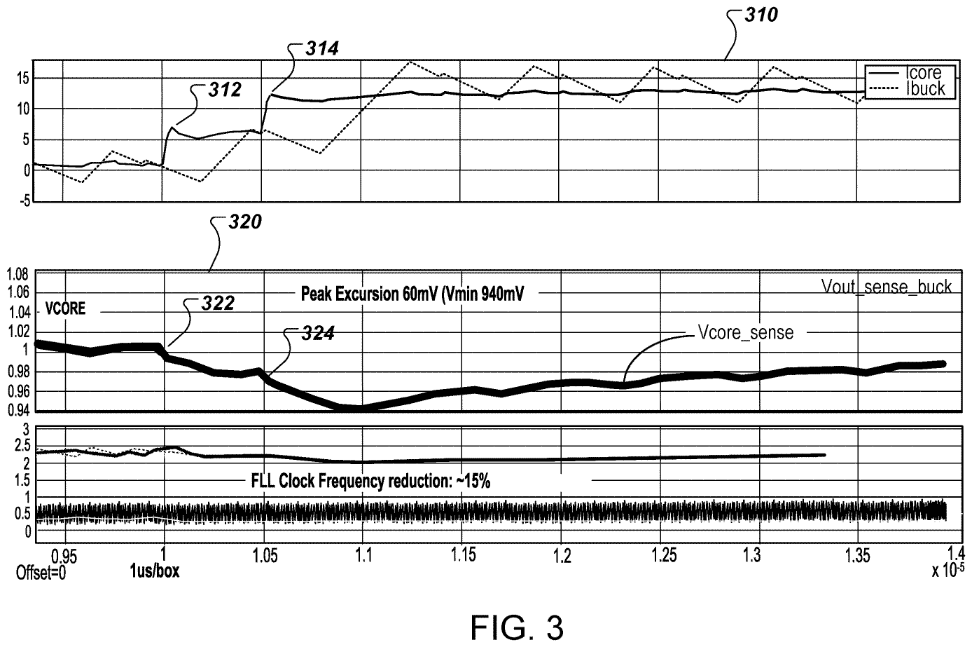

FIG. 3 illustrates how the power manager reacts with architectural mitigation but no synthetic voltage signal.

In FIG. 3, there are three plots on the same time axis. The top plot 310 illustrates how current consumption of the core changes due to a power up, and how the power manager ramps up the current supply to meet the increasing demand.

At 1 microsecond, the core initiates entry into a high power state. This causes a first spike 312 of current consumption of the core and a corresponding first voltage drop 322.

In order to avoid an unsafe drop in voltage, an architectural mitigation subsystem of the core throttles the instructions being executed in order to allow the power manager to catch up on how much current it is supplying.

The power manager uses a voltage feedback signal to detect the first voltage drop 322 and will respond by increasing the supply of current. However, because of inherent delays due to physical components and wire length, the power manager cannot respond with an increase in current until 1.025 microseconds, at which point the current is increased steadily.

When the supplied current finally matches the current consumption, the architectural mitigation is disabled, resulting in a second current spike 314 at 1.05 microseconds and a corresponding second voltage drop 324.

The power manager again senses the second voltage drop 324 but takes time to respond, and, in doing so, steadily increases the supply of supply until it is sufficient to meet the current demands of the high-power state.

As shown in the middle plot 320, voltage in the core had two drop events 322 and 324 corresponding respectively to the current spikes 312 and 314.

And even though the buck power manager was able to increase the current supply to match the current consumption by about 1.12 microseconds, it takes much longer than that for voltage of the core to return to the voltage before the first current spike 312. Overall, the peak voltage excursion was 60 mV relative to the voltage before entering the high-power state.

As shown in the bottom plot 330, even with architectural mitigation, the FLL clock frequency reduction system still required a 15% drop in frequency in order to maintain the voltage in a safe state.

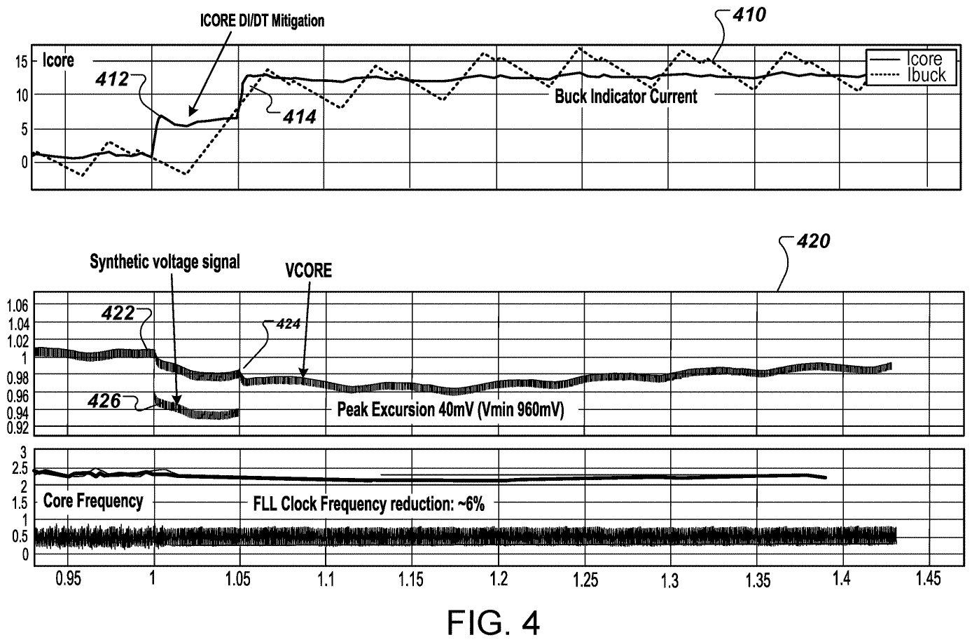

FIG. 4 illustrates the faster reaction time of the power manager when using a synthetic voltage signal. In this example, the compute core uses architectural mitigation to slow the execution frequency, resulting in two current spikes 512 and 514. As shown in the top plot 410, as soon as the first current spike 412 is detected, the system generates a synthetic voltage signal 426 and feeds the synthetic voltage signal 426 into the power manager.

As a result, the power manager initiates a more aggressive increase in current that continues even after the architectural mitigation is removed just before the second spike 414.

As a result, the power manager achieves a current supply that exceeds the current consumption of the core in the high-power state faster than the example illustrated in FIG. 3. When using the synthetic voltage signal, the power manager achieved the goal current with fewer step ups than it would have without the synthetic voltage signal. In this example, the power manager used just one step up increase over less than 0.5 microseconds. The example in FIG. 3 required two current increases and took more than 1 microseconds.

As shown in the bottom plot 420, the core voltage 424 did have two voltage drops 422 and 424 corresponding to the first spike 412 and the second spike 414 respectively, but the voltage drops 422 and 424 were smaller than the voltage drops 322 and 324 that occurred without using a synthetic voltage signal as illustrated in FIG. 3.

In addition, the FLL clock frequency reduction was also smaller, resulting in only a 6% reduction in frequency and only a 40 mV peak voltage excursion.

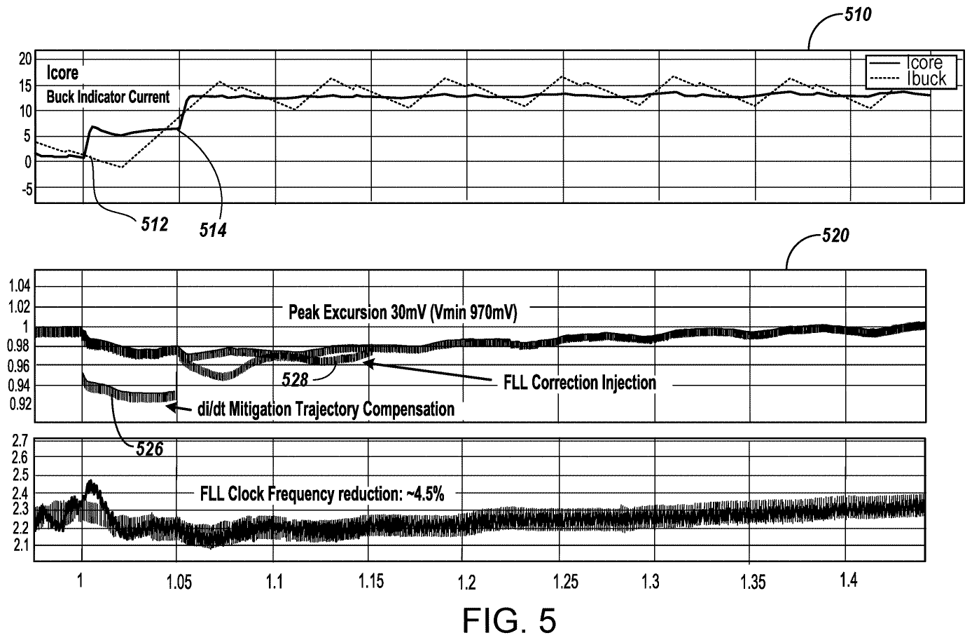

FIG. 5 illustrates how synthetic voltage signals can be used to compensate for both architectural and frequency mitigations in the same system. In this example, the compute core first uses architectural mitigation. Then, when the voltage is still low, the system uses frequency throttling to further mitigate the increased power demands. Similarly to FIGS. 3-4, the architectural mitigation results in two current spikes 512 and 514.

As shown in FIG. 5, the initial transition to the high power state causes a first current spike 512, at which point the compute core implements architectural mitigation.

The system can then generate the trajectory matched synthetic voltage signal 526 in order for the power manager to more aggressively increase the current supplied to the processing core.

When the current supplied by the power manager catches up to current consumed by the processing core, there is a second current spike 514. At this point, the processing core can inject a second synthetic voltage signal 528 to attempt to compensate for frequency throttling, e.g., as implemented by an FLL system.

As a result, the current supplied by the power manager is more steady than the example illustrated in FIG. 4. In other words, when also using synthetic voltage signals to compensate for frequency throttling, the power manager has less oscillation between local high and low current values.

Therefore, less overall frequency throttling is required, and the peak voltage excursion is lower. As shown in FIG. 5, the frequency reduction rate was only 4.5%, and the peak voltage excursion was only 30 mV, compared to 40 mV in FIG. 4, and mV in FIG. 3.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program which may also be referred to or described as a program, software, a software application, an app, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

In addition to the embodiments described above, the following embodiments are also innovative:

Embodiment 1 is a device comprising:
a processing core configured to initiate a transition from executing in a low-power state to executing in a high-power state; and
a power manager configured to increase current supplied to the processing core when the processing core transitions from the low-power state to the high-power state,
wherein the device is configured to inject a synthetic voltage signal into a voltage feedback line of the power manager to cause the power manager to react sooner to the transition by increasing the current supplied to the processing core according to the synthetic voltage signal.

Embodiment 2 is the device of embodiment 1, wherein the device is configured to generate the synthetic voltage signal to compensate for architectural voltage mitigations that limit how quickly instructions can be executed when the processing core transitions to the high-power state.

Embodiment 3 is the device of embodiment 2, wherein the synthetic voltage signal has a trajectory that matches an expected voltage drop due to transitioning to the high-power state.

Embodiment 4 is the device of any one of embodiments 1-3, wherein the device is configured to generate the synthetic voltage signal to compensate for frequency throttling mitigations that limit a clock frequency of the processing core when the processing core transitions to the high-power state.

Embodiment 5 is the device of embodiment 4, wherein the device is configured to generate different synthetic voltage signals to compensate for frequency throttling mitigations and for architectural mitigations.

Embodiment 6 is the device of any one of embodiments 1-5, wherein injecting the synthetic voltage signal causes the power manager to increase current supplied to the processing core in fewer step ups than would be required without the synthetic voltage signal.

Embodiment 7 is the device of any one of embodiments 1-6, wherein injecting the synthetic voltage signal reduces an amount of clock frequency throttling on the processing core when transitioning to the high-power state.

Embodiment 8 is the device of any one of embodiments 1-7, wherein injecting the synthetic voltage signal causes a core frequency of the processing core to regain a voltage level from the low-power state faster than without using synthetic voltage signals.

Embodiment 9 is a method performed by a device having a processing core and a power manager, the comprising:
initiating, by a processing core, a transition from executing in a low-power state to executing in a high-power state;
injecting, by the device, a synthetic voltage signal into a voltage feedback line of the power manager to cause the power manager to react sooner to the transition by increasing the current supplied to the processing core; and
increasing, by the power manager according to the synthetic voltage signal, current supplied to the processing core after the processing core transitions from the low-power state to the high-power state.

Embodiment 10 is the method of embodiment 9, wherein the device is configured to generate the synthetic voltage signal to compensate for architectural voltage mitigations that limit how quickly instructions can be executed when the processing core transitions to the high-power state.

Embodiment 11 is the method of embodiment 10, wherein the synthetic voltage signal has a trajectory that matches an expected voltage drop due to transitioning to the high-power state.

Embodiment 12 is the method of any one of embodiments 9-10, wherein the device is configured to generate the synthetic voltage signal to compensate for frequency throttling mitigations that limit a clock frequency of the processing core when the processing core transitions to the high-power state.

Embodiment 13 is the method of embodiment 12, wherein the device is configured to generate different synthetic voltage signals to compensate for frequency throttling mitigations and for architectural mitigations.

Embodiment 14 is the method of any one of embodiments 9-13, wherein injecting the synthetic voltage signal causes the power manager to increase current supplied to the processing core in fewer step ups than would be required without the synthetic voltage signal.

Embodiment 15 is the method of any one of embodiments 9-14, wherein injecting the synthetic voltage signal reduces an amount of clock frequency throttling on the processing core when transitioning to the high-power state.

Embodiment 16 is the method of any one of embodiments 9-15, wherein injecting the synthetic voltage signal causes a core frequency of the processing core to regain a voltage level from the low-power state faster than without using synthetic voltage signals.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A device comprising:
a processing core configured to initiate a transition from executing in a low-power state to executing in a high-power state; and
a power manager configured to increase current supplied to the processing core when the processing core transitions from the low-power state to the high-power state,
wherein the device is configured to inject a synthetic voltage signal into a voltage feedback line of the power manager to cause the power manager to react sooner to the transition by increasing the current supplied to the processing core according to the synthetic voltage signal.

2. The device of claim 1, wherein the device is configured to generate the synthetic voltage signal to compensate for architectural voltage mitigations that limit how quickly instructions can be executed when the processing core transitions to the high-power state.

3. The device of claim 2, wherein the synthetic voltage signal has a trajectory that matches an expected voltage drop due to transitioning to the high-power state.

4. The device of claim 1, wherein the device is configured to generate the synthetic voltage signal to compensate for frequency throttling mitigations that limit a clock frequency of the processing core when the processing core transitions to the high-power state.

5. The device of claim 4, wherein the device is configured to generate different synthetic voltage signals to compensate for frequency throttling mitigations and for architectural mitigations.

6. The device of claim 1, wherein injecting the synthetic voltage signal causes the power manager to increase current supplied to the processing core in fewer step ups than would be required without the synthetic voltage signal.

7. The device of claim 1, wherein injecting the synthetic voltage signal reduces an amount of clock frequency throttling on the processing core when transitioning to the high-power state.

8. The device of claim 1, wherein injecting the synthetic voltage signal causes a core frequency of the processing core to regain a voltage level from the low-power state faster than without using synthetic voltage signals.

9. A method performed by a device having a processing core and a power manager, the comprising:
initiating, by a processing core, a transition from executing in a low-power state to executing in a high-power state;
injecting, by the device, a synthetic voltage signal into a voltage feedback line of the power manager to cause the power manager to react sooner to the transition by increasing the current supplied to the processing core; and
increasing, by the power manager according to the synthetic voltage signal, current supplied to the processing core after the processing core transitions from the low-power state to the high-power state.

10. The method of claim 9, wherein the device is configured to generate the synthetic voltage signal to compensate for architectural voltage mitigations that limit how quickly instructions can be executed when the processing core transitions to the high-power state.

11. The method of claim 10, wherein the synthetic voltage signal has a trajectory that matches an expected voltage drop due to transitioning to the high-power state.

12. The method of claim 9, wherein the device is configured to generate the synthetic voltage signal to compensate for frequency throttling mitigations that limit a clock frequency of the processing core when the processing core transitions to the high-power state.

13. The method of claim 12, wherein the device is configured to generate different synthetic voltage signals to compensate for frequency throttling mitigations and for architectural mitigations.

14. The method of claim 9, wherein injecting the synthetic voltage signal causes the power manager to increase current supplied to the processing core in fewer step ups than would be required without the synthetic voltage signal.

15. The method of claim 9, wherein injecting the synthetic voltage signal reduces an amount of clock frequency throttling on the processing core when transitioning to the high-power state.

16. The method of claim 9, wherein injecting the synthetic voltage signal causes a core frequency of the processing core to regain a voltage level from the low-power state faster than without using synthetic voltage signals.
